(19) United States
(12) Patent Application Publication
(10) Pub. No.: US 2026/0276825 A1
(43) Pub. Date: Sep. 17, 2026

(54) HYBRID LIDAR SYSTEM CAPABLE OF GENERATING AND DETECTING MULTIPLE WAVEFORMS IN REAL TIME

(71) Applicant: ELECTRONICS AND TELECOMMUNICATIONS RESEARCH INSTITUTE, Daejeon (KR)

(72) Inventors: Munhyun HAN, Daejeon (KR); Bongki MHEEN, Daejeon (KR)

(73) Assignee: ELECTRONICS AND TELECOMMUNICATIONS RESEARCH INSTITUTE, Daejeon (KR)

(21) Appl. No.: 19/021,460

(22) Filed: Jan. 15, 2025

(30) Foreign Application Priority Data
Feb. 22, 2024 (KR) 10-2024-0026016

(51) Int. Cl. G01S 17/89; G01S 7/481; G01S 7/484; G01S 7/4911

(52) U.S. Cl. CPC G01S 17/89; G01S 7/4817; G01S 7/484; G01S 7/4911

(57) ABSTRACT

Provided herein is a hybrid LiDAR system including a light source configured to generate reference light, a first transmitting part configured to modulate the reference light to generate a pulse signal, a second transmitting part configured to modulate a frequency of the reference light to generate a frequency-modulated signal, a single optical detector configured to receive a reflected pulse signal and a reflected frequency-modulated signal generated by the pulse signal and the frequency-modulated signal, and a main controller connected to the single optical detector and configured to use the reflected signals acquired by the single optical detector to acquire three-dimensional images.

### CROSS-REFERENCE TO RELATED APPLICATIONS

This U.S. non-provisional patent application claims priority under 35 U.S.C. § 119 of Korean Patent Application No. 10-2024-0026016, filed on Feb. 22, 2024, the entire contents of which are hereby incorporated by reference.

### BACKGROUND

The present disclosure herein relates to a LiDAR system, and more particularly, to a hybrid LiDAR system capable of generating and detecting multiple waveforms in real time.

A LiDAR has the advantages that it is possible to precisely detect and implement a high-resolution three-dimensional image. Accordingly, the LiDAR is considered as an essential sensor for an autonomous system such as an autonomous vehicle, an artificial intelligent robot, or an unmanned aircraft that has to accurately detect and determine the location and shape of a nearby obstacle such as an autonomous vehicle, an artificial intelligent robot, or an unmanned aircraft, and move safely to the destination. Currently, most of LiDAR technologies are largely divided into a method using a pulsed laser and a method using a frequency-modulated laser as a light source in order to detect a front object. A pulsed light source-based LiDAR system occupies most of the current commercial LiDAR systems due to the advantages of a simple structure, inexpensive cost, and the high-speed operation. However, it is disadvantageous to the eye-safety due to an interference between nearby LiDAR systems and the requirement of peak power of several kW or higher for long-range measurement. In order to address such a limitation, a frequency-modulated continuous-wave (FMCW) LiDAR technology is drawing attention in recent years, the FMCW LiDAR being based on frequency-modulated light source from which coherent detection is possible. Since the coherent detection is possible with the use of the FMCW LiDAR, the FMCW LiDAR is advantageous in interference with other LiDAR signals and enables long-range detection at low power. In particular, as the level of process development of elements such as a light source and an optical detector becomes higher, the elements may be implemented at a level of photonic integrated circuit (PIC) technology, which is advantageous in reducing the power and size. However, a high-performance FMCW LiDAR system requires a narrow-linewidth light source for long-range detection at a km level, and wide-range frequency modulation for high resolution. In order to satisfy such requirements, the cost becomes high and high-speed detection is not easy. Therefore, it is necessary to select a light source having the performance conforming to the requirements of an application. In addition, the current FMCW LiDAR is implemented based on a fiber, which causes a high optical loss and makes it difficult to substantially simultaneously implement wide vertical and horizontal resolutions. Therefore, solutions to address such limitations are required.

### SUMMARY

The present disclosure provides a hybrid LiDAR system for using a single light source and a single optical detector to substantially simultaneously perform short-and long-range measurements at a wide field of view.

An embodiment of the inventive concept provides a hybrid LiDAR system including: a light source configured to generate reference light; a first transmitting part configured to modulate the reference light to generate a pulse signal; a second transmitting part configured to modulate a frequency of the reference light to generate a frequency-modulated signal; a single optical detector configured to receive a reflected pulse signal and a reflected frequency-modulated signal generated by the pulse signal and the frequency-modulated signal; and a main controller connected to the single optical detector and configured to use the reflected signals acquired by the single optical detector to acquire three-dimensional images. Here, the single optical detector may include: a first receiving part configured to detect a coherent signal generated by interference of a local oscillator (LO) signal of the second transmitting part and the reflected frequency-modulated signal; and a second receiving part provided adjacent to the first receiving part and configured to detect the reflected pulse signal.

In an embodiment, the hybrid LiDAR system may further include a first beam splitter provided between the light source and the first and second transmitting parts to split the reference light.

In an embodiment, the first transmitting part may include: a first modulator configured to modulate the reference light to generate the pulse signal; a first amplifier configured to amplify the pulse signal; and a first optical transmission system configured to transmit the pulse signal to an outside.

In an embodiment, the second transmitting part may include: a second modulator configured to modulate the reference light to generate a frequency-modulated signal; a second amplifier configured to amplify the frequency-modulated signal; and a second optical transmission system configured to radiate the frequency-modulated signal.

In an embodiment, the hybrid LiDAR system may further include a second beam splitter provided between the second modulator and the second amplifier to split the reference light.

In an embodiment, the second transmitting part may further include: a signal generation and linearization system provided between the second beam splitter and the second modulator; and a third beam splitter provided between the second beam splitter and the signal generation and linearization system.

In an embodiment, the hybrid LiDAR system may further include a transmission mirror provided between the third beam splitter and the first receiving part and configured to provide the LO signal, which is a portion of the frequency-modulated signal, to the first receiving part.

In an embodiment, the single optical detector may further include a rapid optical detector area.

In an embodiment, each of the first receiving part and the second receiving part may further include sub-optical detector areas.

In an embodiment, each of the first receiving part and the second receiving part may further include a transimpedance amplifier.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 shows an example hybrid LiDAR system according to the present inventive concept;

FIG. 2 shows an example single optical detector of FIG. 1;

FIG. 3 shows examples of a coherent detection area and a rapid high-resolution detection area of the hybrid LiDAR system of FIG. 1;

FIG. 4 shows examples of a first partial area and a second partial area in the coherent detection area and the rapid high resolution detection area of FIG. 3, respectively;

FIG. 5 shows the pulse width and intensity of a pulse signal of a first transmitting part of FIG. 1; and

FIG. 6 shows an example pulse signal of a first transmitting part of FIG. 1 and an example frequency-modulated signal of a second transmitting part of FIG. 1.

### DETAILED DESCRIPTION

Hereinafter, exemplary embodiments of the present disclosure will be described in conjunction with the accompanying drawings. The above and other aspects, features, and advantages of the present disclosure will become apparent from the detailed description of the following embodiments in conjunction with the accompanying drawings. However, it should be understood that the present invention is not limited to the following embodiments and may be embodied in different ways. Rather, the embodiments are provided so that so that this disclosure will be thorough and complete and will fully convey the concept of the invention to those skilled in the art, and the present disclosure will only be defined by the appended claims. Throughout this specification, like numerals refer to like elements.

The terminology used herein is for the purpose of describing particular embodiments only and is not intended to limit the scope of the present disclosure. As used herein, the singular forms “a”, “an” and “the” are intended to include the plural forms as well, unless the context clearly indicates otherwise. It will be further understood that the terms “comprises, includes, has” and/or “comprising, including, having”, when used in this specification, specify the presence of stated features, numbers, steps, operations, elements, components or combinations thereof, but do not preclude the possibility of the presence or addition of one or more other features, numbers, steps, operations, elements, components, and/or combinations thereof. Also, as just exemplary embodiments, reference numerals shown according to an order of description are not limited to the order.

Moreover, exemplary embodiments will be described herein with reference to cross-sectional views and/or plane views that are idealized exemplary illustrations. In the drawings, the thickness of layers and regions are exaggerated for effective description of the technical details. Accordingly, variations from the shapes of the illustrations as a result, for example, of manufacturing techniques and/or tolerances, are to be expected. Thus, exemplary embodiments should not be construed as limited to specific shapes illustrated herein but are to include deviations in shapes that result from manufacturing.

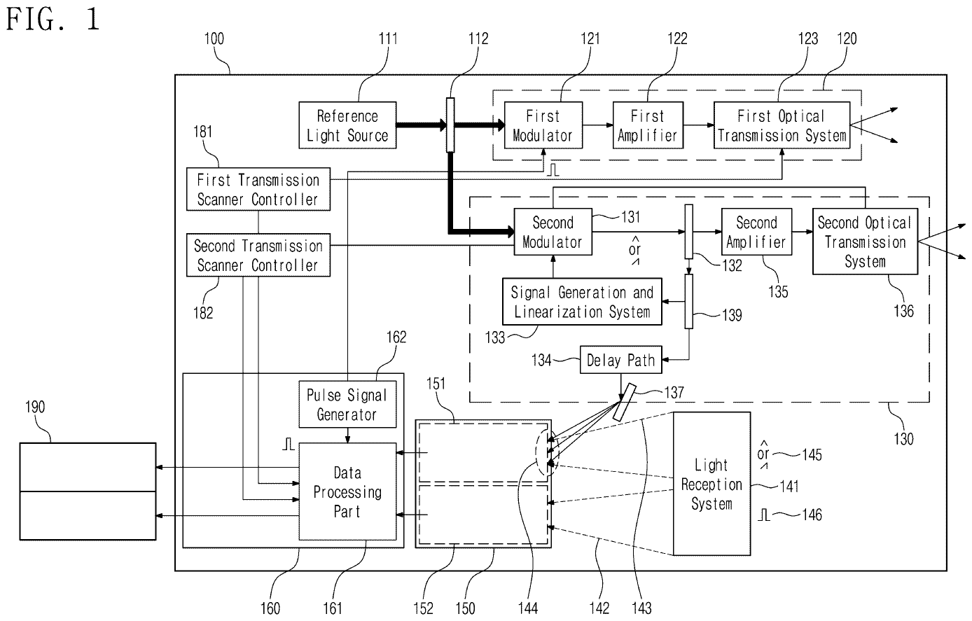

FIG. 1 shows an example hybrid LiDAR system 100 according to the present inventive concept.

Referring to FIG. 1, the hybrid LiDAR system 100 according to the present inventive concept may include a reference light source 111, a first transmitting part 120, a second transmitting part 130, a light reception optical system 141, a single optical detector 150, and a main controller 160.

The reference light source 111 may generate reference light. The reference light may include laser light.

A first beam splitter 112 may be provided between the reference light source 111 and the first light transmitting part 120. The first beam splitter 112 may be provided between the reference light source 111 and the second transmitting part 130. The first beam splitter 112 may divide the reference light and provide the divided light beams to the first transmitting part 120 and the second transmitting part 130.

The first transmitting part 120 may generate a pulse signal of the reference light. The first transmitting part 120 may be controlled by a first transmission scanner controller 181 to externally radiate the pulse signal. According to an example, the first transmitting part 120 may include a first modulator 121, a first amplifier 122, and a first optical transmission system 123. The first modulator 121 may modulate the reference light to generate the pulse signal. The first modulator 121 may be connected to the main controller 160. The main controller 160 may a synchronous signal of the pulse signal to the first modulator 121. The first amplifier 122 may amplify the pulse signal. The first optical transmission system 123 may externally radiate or emit the pulse signal. The first optical transmission system 123 may be controlled by the first transmission scanner controller 181 to provide the pulse signal to a predetermined location. The first optical transmission system 123 may scan the pulse signal to output the scanned signal to the front of the hybrid LiDAR system 100. The first optical transmission system 123 may include a collimator and a scanner. When the pulse-modulated output signal is implemented as a point beam, the scanner included in the first optical transmission system 123 may be implemented in a two-dimensional Galvano or MEMS type.

The second transmitting part 130 may modulate the frequency of the reference light. The second transmitting part 130 may be controlled by a second transmission scanner controller 182 to externally radiate the frequency-modulated signal. The second transmitting part 130 may provide a portion of the reference light to the single optical detector 150. According to an example, the second transmitting part 130 may include a second modulator 131, a second beam splitter 132, a second amplifier 135, a second optical transmission system 136, a third beam splitter 139, a signal generation and linearization system 133, a delay path 134, and a transmission mirror 137. The second modulator 131 may modulate the frequency of the reference light. For example, the frequency-modulated signal may be generated by the second modulator 131 and the signal generation and linearization system 133. The second beam splitter 132 may be provided between the second modulator 131 and the second amplifier 135. The second beam splitter 132 may divide the frequency-modulated signal to provide the divided signals to the second amplifier 135 and the third beam splitter 139. The second amplifier 135 may amplify the frequency-modulated output signal. The second optical transmission system 136 may be controlled by the second transmission scanner controller 182 to externally radiate the frequency-modulated output signal. The second optical transmission system 136 may include a collimator and a scanner. When the frequency-modulated output signal is implemented as a point beam, the scanner included in the second optical transmission system 136 may be implemented in a two-dimensional Galvano or MEMS type. The frequency-modulated output signal may have greater power than the pulse signal. Alternatively, the power of the frequency-modulated output signal may be smaller than that of the pulse signal.

The third beam splitter 139 may be provided between the second beam splitter 132 and the delay path 134. The third beam splitter 139 may provide a signal to the frequency-modulated signal generation and linearization system 133 and the delay path 134. The signal generation and linearization system 133 may be provided between the third beam splitter 139 and the second modulator 131. The signal generation and linearization system 133 may provide a frequency modulation control signal to the second modulator 139, and changes the frequency-modulated signal of the nonlinearity into a signal having linearity. The delay path 134 may be provided between the third beam splitter 139 and the transmission mirror 137. The delay path 134 may transfer the reference light to the transmission mirror 137. The transmission mirror 137 may be provided between the delay path 134 and the single optical detector 150. The transmission mirror 137 may provide a LO signal 138, which is a portion of the linearized frequency-modulated signal, to the single optical detector 150.

The light reception optical system 141 may be provided over the single optical detector 150. The light reception optical system 141 may receive a reflected signal at the front of the hybrid LiDAR system 100. The reflected signal may include reflected light of the pulse signal and the frequency-modulated signal. The light reception optical system 141 may provide a reflected pulse signal 146 and a reflected frequency-modulated signal 145 to the single optical detector 150.

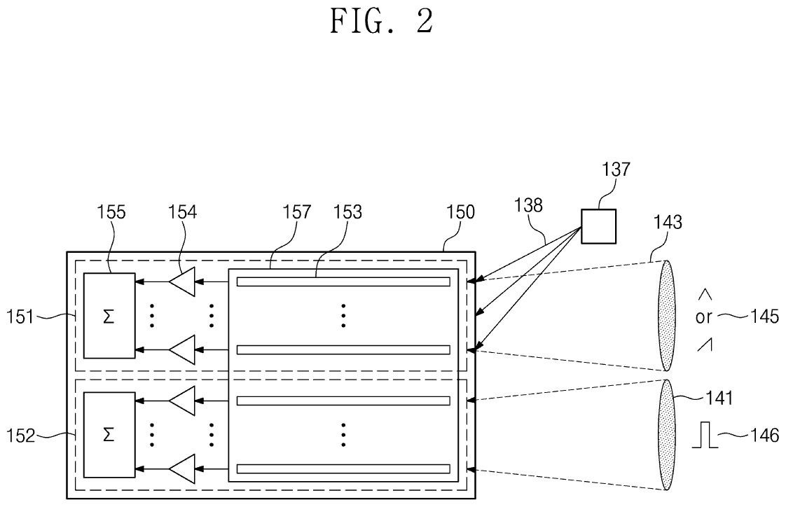

FIG. 2 shows an example of the single optical detector 150 of FIG. 1.

Referring to FIGS. 1 and 2, the single optical detector 150 may be provided between the light reception optical system 141 and the main controller 160. The single optical detector 150 may detect the reflected pulse signal 146. According to an example, the single optical detector 150 may include a first receiving part 151 and a second receiving part 152. The first receiving part may receive an interference signal of the reflected frequency-modulated signal 145 and the LO signal. For example, the first receiving part 151 may detect a coherent signal generated by the interference 144 of the reflected frequency-modulated signal 145 and the LO signal 138. The second receiving part 152 may be provided adjacent to the first receiving part 151. The second receiving part 152 may detect the reflected pulse signal 146. The main controller 160 may use the detected signal of the coherent signal generated in the interference area 144 and the detected signal of the reflected pulse signal 146 to acquire respective three-dimensional images. Accordingly, the single optical detector 150 may simultaneously detect the reflected pulse signal 146 and the coherent signal generated in the interference area 144 to secure the short and long-range signals of the three-dimensional images and to increase the detection reliability.

The main controller 160 may include a data processing part 161 and a pulse signal generator 162. The data processing part 161 may use the reflected pulse signal 146 and the detected signal of the coherent signal generated in the interference area 144 to acquire and display the three-dimensional images on a display device 190. The pulse signal generator 162 may be connected between the data processing part 161 and the first modulator 121. The pulse signal generator 162 may provide a synchronous signal of the pulse signal to the first modulator 121.

According to an example, each of the first receiving part 151 and the second receiving part 152 may include a high-speed optical detector area 157, sub-light detection areas 153, a transimpedance amplifier (TIA) 154, and detection controllers 155. In the high-speed optical detector area 157, the coherent signal generated in the interference area 144 and the reflected pulse signal 146, which are respectively generated from the frequency-modulated LO signal 138 and the reflected frequency-modulated signal 145 passing through the interference area 144, may be received and rapidly processed. In the sub-light detection areas 153, the coherent signal and the reflected pulse signal 146, may be received and processed in a small-scale area.

The TIAs 154 may amplify the coherent signal and the detected signal of the reflected pulse signal 146. The detection controllers 155 may respectively synthesize the signals detected by the first receiving part 151 and the second receiving part 152 to process the synthesized signals so as to be output as respective single signals. The pulse signal and the frequency-modulated signal output by the signal synthesis circuit 155 are processed to acquire the respective three-dimensional images.

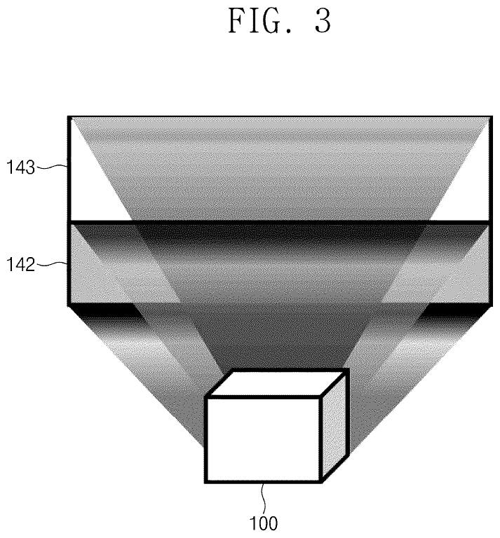

FIG. 3 shows examples of a coherent detection area and a rapid detection area through pulse measurement of the hybrid LiDAR system 100 of FIG. 1.

Referring to FIG. 3, the hybrid LiDAR system 100 may scan a wide area at one time, and divide the wide area into a scan area and a detection area on the basis of a light source of multiple waveforms and real-time detection characteristics. For example, the hybrid LiDAR system 100 may separate up and down a pulse-based rapid detection area 142 and a coherent detection area 143 to acquire the three-dimensional images.

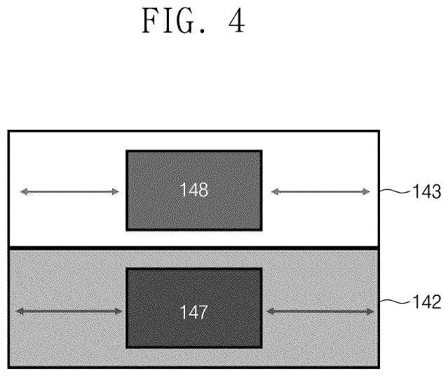

FIG. 4 shows examples of a first partial area 147 and a second partial area 148 in the pulse-based rapid detection area 142 and the coherent detection area 143 of FIG. 3.

Referring to FIG. 4, the hybrid LiDAR system 100 may acquire high resolution images of desired regions of interest (ROI) of the first partial area 147 and the second partial area 148 in the pulse-based rapid detection area 142 and the coherent detection area 143 on the basis of the advantages of utilizing a two-axis mirror and securing a wide detection area.

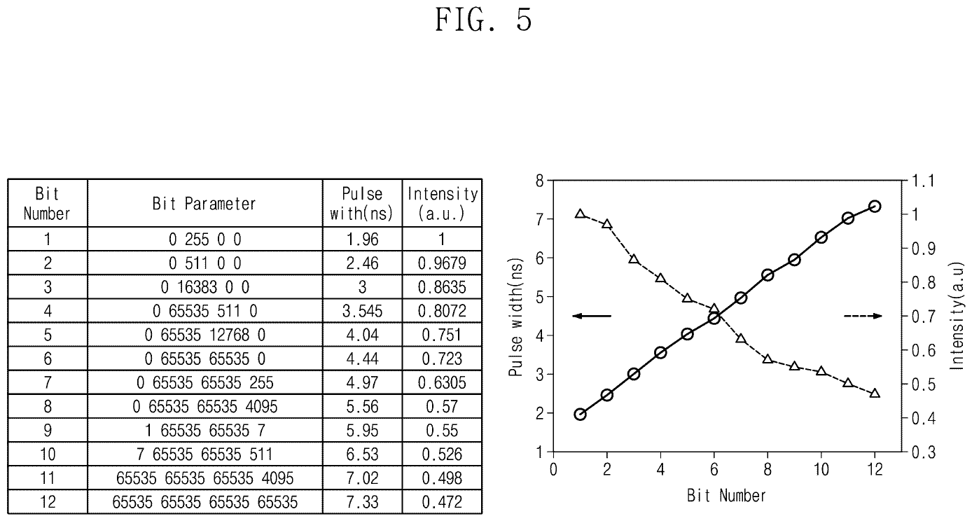

FIG. 5 shows the pulse width and intensity of the pulse signal of the first transmitting part of FIG. 1.

Referring to FIG. 5, the hybrid LiDAR system 100 may adjust the pulse width and intensity of the pulse signal according to a user and an application environment.

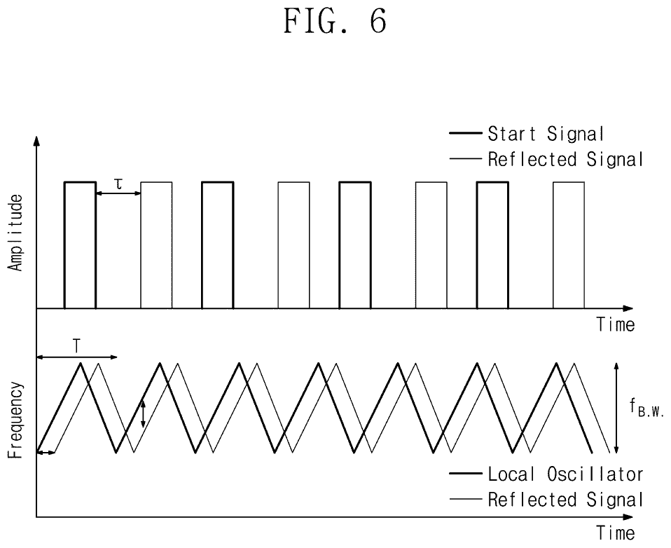

FIG. 6 shows an example pulse signal of the first transmitting part 129 of FIG. 1 and an example frequency-modulated signal of the second transmitting part of FIG. 1.

Finally, the hybrid LiDAR system 100 according to the inventive concept may increase the reliability using the single optical detector 150 including the first receiving part 151 configured to detect the coherent signal and the second receiving part 152 configured to detect the reflected pulse signal.

As described above, the hybrid LiDAR system of the inventive concept may use the single optical detector including the frequency receiving part and the pulse receiving part to substantially simultaneously perform short-and long-range measurements at a wide field of view, thereby increasing the reliability.

The example embodiments of the present disclosure have been described above with reference to the accompanying drawings, but those skilled in the art will understand that the present disclosure may be implemented in another concrete form without changing the technical spirit or an essential feature thereof. Therefore, the aforementioned example embodiments are all illustrative and are not restricted to a limited form.

What is claimed is:

1. A hybrid LiDAR system comprising:
a light source configured to generate reference light;
a first transmitting part configured to modulate the reference light to generate a pulse signal;
a second transmitting part configured to modulate a frequency of the reference light to generate a frequency-modulated signal;
a single optical detector configured to receive a reflected pulse signal and a reflected frequency-modulated signal generated by the pulse signal and the frequency-modulated signal; and
a main controller connected to the single optical detector and configured to use the reflected signals acquired by the single optical detector to acquire three-dimensional images,
wherein the single optical detector comprises:
a first receiving part configured to detect a coherent signal generated by interference of an LO signal of the second transmitting part and the reflected frequency-modulated signal; and
a second receiving part provided adjacent to the first receiving part and configured to detect the reflected pulse signal.

2. The hybrid LiDAR system according to claim 1, further comprising a first beam splitter provided between the light source and the first and second transmitting parts to split the reference light.

3. The hybrid LiDAR system according to claim 1, wherein the first transmitting part comprises:
a first modulator configured to modulate the reference light to generate the pulse signal;
a first amplifier configured to amplify the pulse signal; and
a first optical transmission system configured to transmit the pulse signal to an outside.

4. The hybrid LiDAR system according to claim 1, wherein the second transmitting part comprises:
a second modulator configured to modulate the reference light to generate a frequency-modulated signal;
a second amplifier configured to amplify the frequency-modulated signal; and
a second optical transmission system configured to radiate the frequency-modulated signal.

5. The hybrid LiDAR system according to claim 4, further comprising a second beam splitter provided between the second modulator and the second amplifier to split the reference light.

6. The hybrid LiDAR system according to claim 5, wherein the second transmitting part further comprises:
a signal generation and linearization system provided between the second beam splitter and the second modulator; and
a third beam splitter provided between the second beam splitter and the signal generation and linearization system.

7. The hybrid LiDAR system according to claim 6, further comprising a transmission mirror provided between the third beam splitter and the first receiving part and configured to provide the LO signal, which is a portion of the frequency-modulated signal, to the first receiving part.

8. The hybrid LiDAR system according to claim 1, wherein the single optical detector further comprises a rapid optical detector area.

9. The hybrid LiDAR system according to claim 1, wherein each of the first receiving part and the second receiving part further comprises sub-optical detector areas.

10. The hybrid LiDAR system according to claim 1, wherein each of the first receiving part and the second receiving part further comprises a transimpedance amplifier.
